(19) United States
(12) Patent Application Publication
(10) Pub. No.: US 2007/0296845 A1
(43) Pub. Date: Dec. 27, 2007

(54) Mobile terminal device, controlling device, controlling method, and computer product

(75) Inventors: Hideaki Watanabe, Kawasaki (JP); Kyoko Nishinaga, Kawasaki (JP); Shinichi Wakayama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/589,168

(22) Filed: Oct. 30, 2006

(30) Foreign Application Priority Data
Jun. 26, 2006 (JP) 2006-175161

(51) Int. Cl. H04N 5/222

(52) U.S. Cl. 348/333.12

(57) ABSTRACT

A magnifier-and-focus switching unit switches the focal distance of an image acquiring unit and an object from a focal distance for normal photography to a focal distance for close-up photography. As a result, the image acquiring unit acquires an image at the focal distance for the close-up photography. A zoom processing unit enlarges the image acquired by the image acquiring unit and a displaying unit displays the enlarged image.

### BACKGROUND OF THE INVENTION

1. Field of the Invention

The present invention generally relates to a mobile terminal device having a function to acquire and display images, and particularly relates to a mobile terminal device having a magnifying glass function.

2. Description of the Related Art

Recently, among mobile terminal devices such as a cellular telephone and a personal digital assistant (PDA), those of a type that are equipped with a camera (image acquiring device) having close-up and zooming capabilities are becoming popular. A technology for realizing a magnifying capability (magnifier) on such a mobile terminal device has been conceived, by photographing characters of a small font on paper, such as a newspaper, with the camera of the mobile terminal device and magnifying and presenting them on the display. This technology helps weak-sighted elderly people or other users read characters of a small font by use of a cellular phone or the like. Conventional techniques have been disclosed in Japanese Patent Application Laid-open No. 2002-374450 Japanese Patent Application Laid-open No. 2004-153407.

FIG. 7 is a functional block diagram of a structure of a conventional camera-equipped cellular telephone 100. The cellular telephone 100 includes a keyboard 101 through which various operations are input, a receiver 102 that outputs the voice of a person at the other end of the line during a call, an antenna 103 that transmits and receives radio wave signals during a call or data communications, a microphone 104 to which the user's voice is input, a displaying unit 105 that presents various types of information, a light 106 that illuminates an object during photographing, a camera unit 110, a communicating unit 120 that controls transmission and reception of radio wave signals, and a controlling unit 130 that controls the functional units.

The camera unit 110 acquires an image of an object, and includes a focus switching unit 111, an image acquiring unit 112, and a zoom processing unit 113. The focus switching unit 111 serves to optically change the focal distance between the image acquiring unit 112 and the object by moving the position of a lens (not shown) and thereby switch the image acquiring mode from a normal mode to a close-up mode for acquiring a close-up photograph. The image acquiring unit 112 is a camera that acquires an image of the object. The zoom processing unit 113 serves to perform a process called digital zooming, with which an image acquired by the image acquiring unit 112 is digitally enlarged or reduced by means of a software program.

When the camera (image acquiring unit 112) of the cellular telephone 100 is used as a magnifier, the user first controls the focus switching unit 111 to switch the image acquiring mode to the close-up mode, and then looks at the image captured by the image acquiring unit 112 on the displaying unit 105. Further, while looking at the image output on the displaying unit, the user controls the zoom processing unit 113 to increase the zoom scaling factor until the image output on the displaying unit 105 is easy to see. With these controls, the user can browse a small-font object such as a newspaper under magnification.

When the magnifying function is used on the conventional mobile terminal device, the user needs to switch the image acquiring mode and then change the zoom scaling factor to adjust the image to an easily viewable size. The conventional device therefore does not offer a very good operability.

### SUMMARY OF THE INVENTION

It is an object of the present invention to at least partially solve the problems in the conventional technology.

According to an aspect of the present invention, a mobile terminal device includes a focal-distance setting unit that sets a focal distance to any one of a first focal distance and a second focal distance; an image acquiring unit that acquires an image of an object based on the focal distance set by the focal-distance setting unit; a scaling-factor setting unit that sets a scaling factor of the image acquired by the image acquiring unit in accordance with the focal distance set by the focal-distance setting unit; and a displaying unit that display the image acquired by the image acquiring unit at the scaling factor set by the scaling-factor setting unit.

According to another aspect of the present invention, a controlling device for a mobile terminal device, wherein the mobile terminal device includes an image acquiring unit configured to acquire an image of an object and a display unit configured to display acquired image, includes a focal-distance setting unit that sets a focal distance of the image acquiring unit to any one of a first focal distance and a second focal distance; and a scaling-factor setting unit that sets a scaling factor of the image in accordance with the set focal distance by the focal-distance setting unit.

According to still another aspect of the present invention, a method of controlling a mobile terminal device, wherein the mobile terminal device includes an image acquiring unit configured to acquire an image of an object and a display unit configured to display acquired image, includes setting a focal distance of the image acquiring unit to any one of a first focal distance and a second focal distance; and setting a scaling factor of the image in accordance with set focal distance.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a cellular telephone according to a first embodiment of the present invention;

FIG. 2 is a perspective view of an example of the cellular telephone shown in FIG. 1;

FIG. 3 is a flowchart for explaining the processing procedure performed by the cellular telephone shown in FIG. 2;

FIG. 4 is depicts an example of a function selection menu displayed on a cellular telephone according to a second embodiment of the present invention;

FIG. 5 is a functional block diagram of a cellular telephone according to a third embodiment of the present invention;

FIG. 6 is a functional block diagram for explaining software structure of a cellular telephone for implementing the first to third embodiments; and

FIG. 7 is a functional block diagram of a conventional camera-equipped cellular telephone.

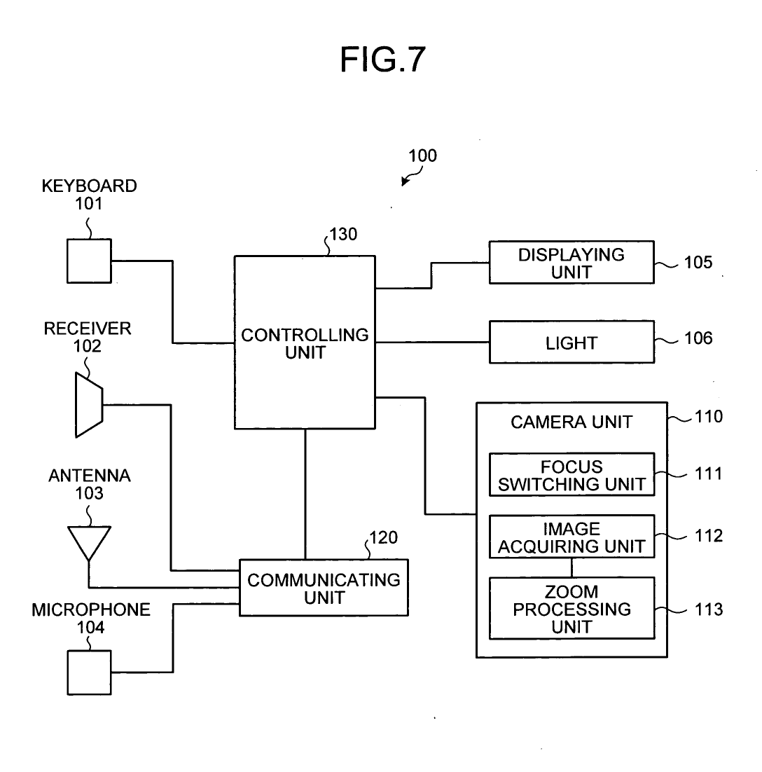

### DETAILED DESCRIPTION OF THE PREFERRED EMBODIMENTS

Exemplary embodiments of the mobile terminal device as well as the controlling device, controlling method, and controlling program for the mobile terminal device according to the present invention will be explained in detail with reference to the attached drawings. In the following explanation, the application of the present invention to a camera-equipped cellular telephone will be discussed. The discussion will mainly focus on ‘the first focal distance’ being a focal distance for normal photographing and ‘the second focal distance’ being a focal distance for close-up photography.

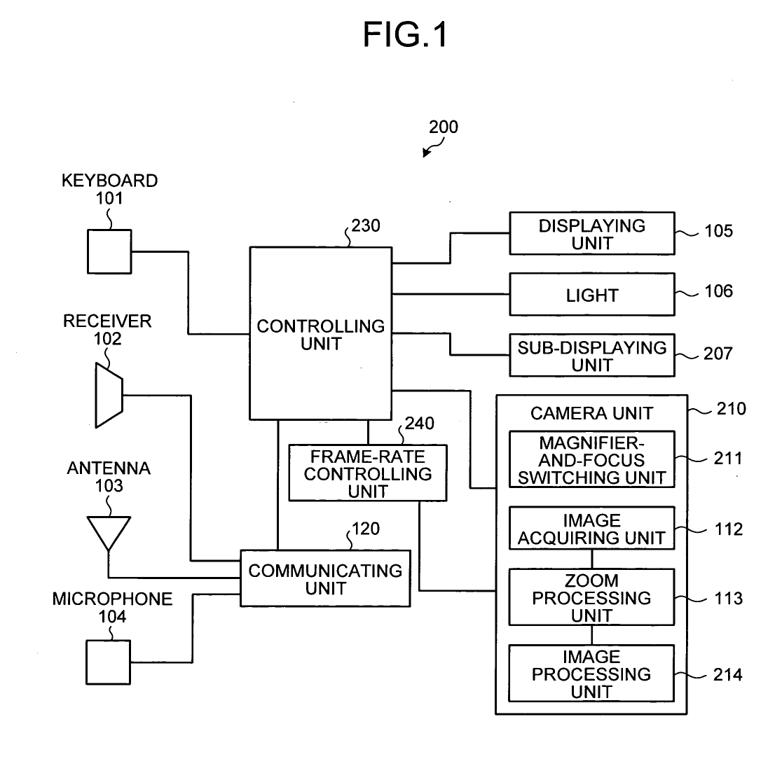

First, a structure of a cellular telephone according to a first embodiment will be explained. FIG. 1 is a functional block diagram of a cellular telephone 200 according to the first embodiment. The cellular telephone 200 includes a keyboard 101 through which various operations are input, a receiver 102 that outputs the voice of a person at the other end of the line during a call, an antenna 103 that transmits and receives radio wave signals during telephone and data communications, a microphone 104 through which the voice of a user is input, a displaying unit 105 that is a display that presents various types of information, a light 106 that illuminates an object at the time of acquiring an image, a sub-displaying unit 207, a camera unit 210 that acquires an image of the object, a communicating unit 120 that controls the transmission and reception of radio wave signals, a controlling unit 230 that controls all the functional units, and a frame-rate controlling unit 240.

The light 106 serves as an auxiliary light when the camera of the cellular telephone 200 is used as a magnifier. This allows an object to be shot under sufficient lighting even when, for example, the cellular telephone 200 is used in a dark place or the cellular telephone 200 itself blocks external light at the time of bringing the lens close to the object.

The sub-displaying unit 207 is a display such as a liquid crystal display (LCD) that displays various types of information similarly to the displaying unit 105. It displays, for example, a menu for operating the cellular telephone 200 and icons that notify a user of an incoming call and received e-mail.

The camera unit 210 acquires an image of an object, and includes a magnifier-and-focus switching unit 211, an image acquiring unit 112, a zoom processing unit 113, and an image processing unit 214.

The magnifier-and-focus switching unit 211 changes the focal distance between the image acquiring unit 112 and the object by moving the position of the lens that is not shown, and thereby switches the image acquiring mode from the normal mode to the close-up mode for acquiring a close-up photograph. The magnifier-and-focus switching unit 211 also gives an instruction to the camera of the cellular telephone 200 to bring it to a state of being usable as a magnifier (hereinafter, ‘magnifier use state’).

More specifically, the magnifier-and-focus switching unit 211 is a switch, such as of a sliding type, which can switch between at least two states, the ordinary use state and the magnifier use state. The magnifier-and-focus switching unit 211 is mechanically connected to the lens so that, when the user controls to switch it from the ordinary use state to the magnifier use state, the position of the lens is changed in synchronization with this control until the distance between the object and the image acquiring unit 112 coincides with the focal distance for acquiring the close-up photographs. At the same time, the magnifier-and-focus switching unit 211 gives an instruction to the controlling unit 230 to set the magnifier mode.

On the other hand, when the camera is switched from the magnifier use state to the ordinary use state, the magnifier-and-focus switching unit 211 changes the position of the lens until the distance between the object and the image acquiring unit 112 coincides with a focal distance predetermined for acquiring ordinary-range image, and instructs the controlling unit 230 to cancel the magnifier mode.

The image acquiring unit 112 acquires an image of the object. The zoom processing unit 113 is a processing unit that performs a process called digital zooming, which enlarges and reduces the image by means of a software program.

The image processing unit 214 is a processing unit that processes the image presented on the displaying unit 105 in such a manner as to make the characters easily viewable. In particular, the image processing unit 214 enhances the high-frequency region, or adjusts the contrast, of the image output by the zoom processing unit 113 in accordance with the operation of the magnifier-and-focus switching unit 211 so that the user can easily view the characters.

With the image processing unit 214 processing the image to make the characters easily viewable, the image can be output on the display with a high visibility, improving the convenience in using the camera as a magnifier.

The frame-rate controlling unit 240 is a processing unit that sends the image acquiring unit 112 an instruction to fix the frame rate of the image to be output onto the displaying unit 105 to a predetermined rate. In use of the camera as a magnifier, the user moves the cellular telephone 200 as tracing the characters of the object with the lens. At this point, if the frame rate of the image output by the image acquiring unit 112 is too low, the image would not be smoothly displayed on the displaying unit 105, significantly lowering the operability of the magnifying function of the cellular telephone 200.

In general, the frame rate should be kept equal to or higher than a constant rate around 15 to 30 frames per second to attain an excellent operability of the magnifying function. The frame-rate controlling unit 240 therefore sends an instruction to the image acquiring unit 112 to fix the frame rate of the to-be-output image to a rate predetermined in the range of 15 to 30 frames per second. For instance, the frame-rate controlling unit 240 sends an instruction to the image acquiring unit 112 to fix the frame rate of the to-be-output image to 30 frames per second.

With the frame-rate controlling unit 240 providing an instruction to the image acquiring unit 112 to fix the frame rate of the to-be-output image to a predetermined rate, an image is stably presented on the displaying unit 105, and the operability is improved in use of the camera of the cellular telephone 200 as a magnifier.

In this example, the frame-rate controlling unit 240 sends an instruction to the image acquiring unit 112 to fix the frame rate of the to-be-output image to a predetermined rate, but the frame rate may be kept equal to or higher than a predetermined rate. For instance, the frame-rate controlling unit 240 may instruct the image acquiring unit 112 to keep the frame rate of the to-be-output image equal to or higher than 15 frames per second.

The controlling unit 230 is a processing unit that controls the entire cellular telephone 200. More specifically, the controlling unit 230 causes the cellular telephone 200 to function as an integrated device by performing transfer of controls and exchange of data between the functional units, the startup and shutdown-of applications, and the like. The processes of the controlling unit 230 that are closely associated with the present invention include a process of, in response to an instruction from the magnifier-and-focus switching unit 211 to set the magnifier mode, turning the light 106 on and also controlling the image acquiring unit 112 to start the internal output of an acquires image to the zoom processing unit 113.

At the same timing, the controlling unit 230 causes the frame-rate controlling unit 240 to fix the frame rate of the image output from the image acquiring unit 112 to the zoom processing unit 113 to a predetermined rate. Thereafter, the controlling unit 230 causes the zoom processing unit 113 to increase the size of the image to a specific zoom scaling factor, and outputs the enlarged image to the image processing unit 214. Further, the controlling unit 230 causes the image processing unit 214 to process the image enlarged by the zoom processing unit 113, and outputs the processed image onto the displaying unit 105.

On the other hand, upon receipt of an instruction of canceling the magnifier mode from the magnifier-and-focus switching unit 211, the controlling unit 230 turns the light 106 off, and causes the image acquiring unit 112 to stop the output of the image to the zoom processing unit 113. The controlling unit 230 also causes the frame rate controlling 240 to put the frame rate of the image output from the image acquiring unit 112 to the zoom processing unit 113 back to the rate for the normal mode, and causes the zoom processing unit 113 to put the size of the image to be output to the image processing unit 214 to the zoom scaling factor for the normal mode. Finally, the controlling unit 230 causes the image processing unit 214 to stop the processing of the image that is to be output onto the displaying unit 105.

As described above, once the magnifier- and focus switching unit 211 switches the camera to the magnifier use state, each functional unit is switched at the same timing to a necessary state to make the camera of the cellular telephone 200 usable as a magnifier. Hence, the user can readily bring the camera of the cellular telephone 200 to a magnifier operable state with a single operation.

In this example, the cellular telephone 200 is configured to include the light 106 to illuminate an object. The cellular telephone 200, however, may be designed to have the sub-displaying unit 207 whose displaying surface faces the same direction as a direction of acquiring the image with the image acquiring unit 112 so that, when turned on, it can be used in place of the light 106. This design does not require the light 106 and thereby reduces the cost of producing the cellular telephone 200.

In addition, in this example, the camera of the cellular telephone 200 is used as a magnifier by magnifying and outputting the image acquired by the image acquiring unit 112 onto the displaying unit 105. The image can also be reduced and output onto the displaying unit 105. More specifically, in response to the user's operation, the magnifier-and-focus switching unit 211 switches the image acquiring mode from the normal mode to the close-up mode. The magnifier-and-focus switching unit 211 also sends an instruction to the controlling unit 230 to set the reduction mode, upon receipt of which the controlling unit 230 causes the zoom processing unit 113 to reduce the zoom scaling. This allows an image of a wider range to be output onto the displaying unit 105 than in the normal mode of the camera. The user can thereby display and shoot the object of the targeted object in a wider range with a single operation when, for example, the image does not fit in the displaying unit 105.

Furthermore, the cellular telephone 200 may be configured to switch among three modes, normal mode, magnifier mode, and reduction display mode, by incorporating a switch that can switch among at least three modes as the magnifier-and-focus switching unit 211. This allows the user to determine whether to use the camera as a magnifier or for reduction display and make a selection with a single operation, depending on the user's needs. This further improves the convenience in use of the camera of the cellular telephone 200.

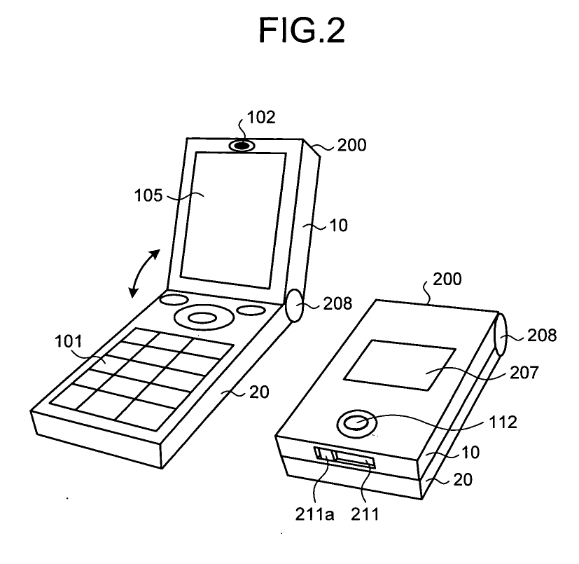

Next, an example of the cellular telephone according to the first embodiment will be described. FIG. 2 is a perspective view of an example of the cellular telephone 200 according to the first embodiment. The cellular telephone 200 shown in this drawing is a clamshell-type camera-equipped telephone that includes a first housing 10 and a second housing 20. The first housing 10 and the second housing 20 are connected by means of a hinge unit 208 and configured to be rotatably movable and foldable about the hinge unit 208. The cellular telephone 200 in the open position is described on the left side of the drawing, while the cellular telephone 200 in the closed position is described on the right side of the drawing.

The first housing 10 serves as a telephone receiver, and includes a receiver 102 and a display 105 on the inner surface in the folded position, and an image acquiring unit (camera) 112 and a sub-displaying unit 207 on the outer surface. The first housing 10 also houses an antenna 103 and a camera unit 210.

As shown in the drawing, the first housing 10 includes the sub-displaying unit 207 whose display surface faces the same direction as the direction of acquiring of the image with the image acquiring unit 112. The sub-displaying unit 207 therefore can be used in place of the light 106, with the emitted light when it is turned on.

In addition, the first housing 10 includes a magnifier-and-focus switching unit 211 as part of the camera unit 210 on its top end surface. The magnifier-and-focus switching unit 211 is a switch of a sliding type as indicated in the drawing. When the switching lever 211a is moved from one end to the other, the cellular telephone 200 is switched between the normal use state and the magnifier use state.

Meanwhile, the second housing 20 serves as a telephone transmitter and includes a keyboard 101 on the inner surface in the folded position. The second housing 20 also houses a microphone 104, a communicating unit 120, a controlling unit 230, and a frame-rate controlling unit 240.

In this example, the magnifier-and-focus switching unit 211 is arranged on the top end surface of the first housing. The arrangement of the magnifier-and-focus switching unit 211 is not limited to this, however. The magnifier-and-focus switching unit 211 may be positioned anywhere as long as the lens can be moved simultaneously with the movement of the switch.

Moreover, in this example, the magnifier-and-focus switching unit 211 is configured as a switch of a sliding type. The configuration of the magnifier-and-focus switching unit 211 is not limited to this, however, and may be a switch of a different type, such as a push-button switch.

Furthermore, in this example, the cellular telephone 200 is of a clamshell type. The present invention is not limited to this, however, and is equally applicable to bar-type and flip-type cellular telephones.

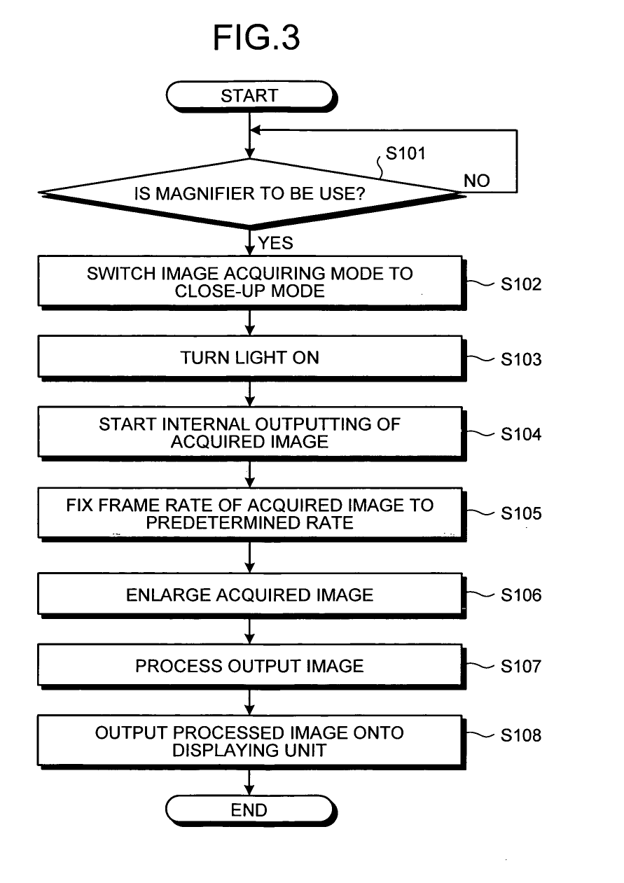

Next, the processing procedure of the cellular telephone 200 according to the first embodiment in magnifier mode will be explained. FIG. 3 is a flow chart for explaining the processing procedure of the cellular telephone 200 according to the first embodiment when it is set to the magnifier mode. In the cellular telephone 200, as illustrated in this drawing, when the magnifier-and-focus switching unit 211 is switched to the magnifier mode with the user's operation (Step S101, Yes), the magnifier-and-focus switching unit 211 switches the image acquiring mode to the close-up mode in synchronization with this operation (Step S102). In addition, the controlling unit 230 turns on the light 106 (or the sub-displaying unit 207) (Step S103), and the image acquiring unit 112 starts internal outputting of an acquired image to the zoom processing unit 113 (Step S104).

Then, the frame-rate controlling unit 240 fixes the frame rate of the image that is to be output from the image acquiring unit 112 to the zoom processing unit 113, to a predetermined rate (Step S105). The zoom processing unit 113 magnifies the image output from the image acquiring unit 112 by a predetermined zoom scaling factor and outputs it to the image processing unit 214 (Step S106). Furthermore, the image processing unit 214 processes the image output from the zoom processing unit 113 (Step S107), and outputs the processed image to the displaying unit 105 (Step S108).

When the magnifier-and-focus switching unit 211 is switched to the magnifier mode, the light 106 is turned on, and the image is displayed on the displaying unit 105. At the same time, processes (frame rate fixing and image processing) are performed on the displayed image. In this manner, the user can readily bring the camera of the cellular telephone 200 to a state of being usable as a magnifier, with a single operation.

As described above, the magnifier-and-focus switching unit 211 switches the focal distance between the image acquiring unit 112 and the object from the focal distance for normal photography to the focal distance for close-up photography. In accordance with this switching, the magnifier-and-focus switching unit 211 switches the image acquiring mode to the close-up mode; the controlling unit 230 turns the light 106 that serves as an auxiliary light; the image acquiring unit 112 starts outputting the acquired image to the displaying unit 105; the zoom processing unit 113 enlarges the image output from the image acquiring unit 112, by use of a digital zooming process; the frame-rate controlling unit 240 fixes the frame rate of the image to a certain rate; and the image processing unit 214 processes the image. Hence, the user can enlarge the image presented on the display with a single, simple operation and readily use the image acquiring device as a magnifier or the like. This increases the utilization value of the camera-equipped mobile terminal device for users who tend to avoid complicated operations and elderly users whose vision is not clear enough to read small-font characters without a magnifying glass.

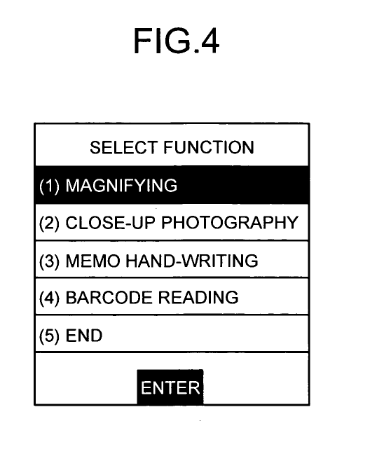

A camera incorporated in a cellular telephone is not only used as a magnifying glass, but also for standard close-up photography and as a code reader for reading a quick response (QR) code or a barcode, for example. According to a second embodiment, a function selection menu on which a selection is made from various functions is displayed on the displaying unit 105 when a user's operation is input into the magnifier-and-focus switching unit 211. A cellular telephone according the second embodiment has basically the same structure as the cellular telephone 200 according to the first embodiment. The second embodiment differs from the first embodiment only in that the controlling unit 230 displays a function selection menu when receiving an instruction of setting the magnifier mode from the magnifier-and-focus switching unit 211, and executes a process in correspondence with a function selected by the user. In the following explanation, the function selection menu that is displayed by the cellular telephone according to the second embodiment will be described with reference to FIG. 4.

FIG. 4 is a diagram for explaining an example of a function selection menu displayed on the cellular telephone according to the second embodiment. The function selection menu shown here indicates an example of a function selection menu for using the camera of the cellular telephone as a magnifier, for close-up photography, for memo hand-writing or as a barcode reader. When a user makes a selection from among the items ‘magnifying’, ‘close-up photography’, ‘memo hand-writing’, and ‘barcode reading’, the controlling unit 230 executes a process that corresponds to the selected function. When ‘end’ is selected, the controlling unit 230 closes the function selection menu and displays a predetermined screen such as a standby screen.

For instance, when ‘magnifier’ is selected, the controlling unit 230 establishes the magnifier mode, as explained in the first embodiment. When ‘close-up photography’ is selected, the controlling unit 230 causes the zoom processing unit 113 to fix the zoom scaling factor of the image to 1, while when ‘barcode reading’ is selected, a barcode is extracted and read from the image output from the image acquiring unit 112.

As described above, according to the second embodiment, when the magnifier-and-focus switching unit 211 is switched to the magnifier mode, the controlling unit 230 displays the function selection menu on the displaying unit 105 and executes a process in correspondence with the function selected by the user. Thus, the user can use the camera and realize various functions therewith, with a simple operation.

As explained in the first and second embodiments, the use of the camera of a cellular telephone as a magnifier requires more functional units to operate than the normal use does. This inevitably means that more power is consumed under the magnifier use than the normal use. A third embodiment provides a cellular telephone having reduced power consumption when the phone is left idle in the magnifier mode.

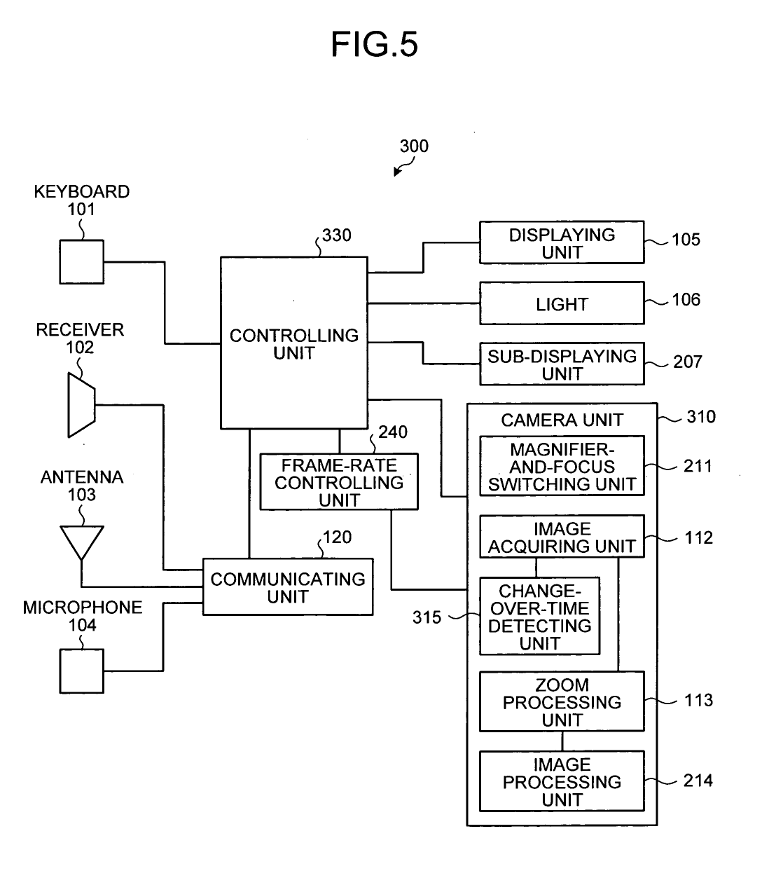

First, the structure of a cellular telephone according to the third embodiment will be explained. FIG. 5 is a functional block diagram of a cellular telephone 300 according to the third embodiment. For the sake of simplicity, the same numerals are assigned to functional units that serve similar functions to the units illustrated in FIG. 1, and detailed explanations thereof are omitted.

The cellular telephone 300 includes a keyboard 101 through which various operations are input, a receiver 102 that outputs the voice of a person at the other end of the line during a call, an antenna 103 that transmits and receives radio wave signals during telephone and data communications, a microphone 104 through which the voice of a user is input, a displaying unit 105 that displays various types of information, a light 106 that illuminates an object when acquiring an image thereof, a sub-displaying unit 207, a camera unit 310 that acquires an image of the object, a communicating unit 120 that controls transmission and reception of the radio wave signals, a controlling unit 330 that controls various functional units, and a frame-rate controlling unit 240.

The camera unit 310 acquires an image of an object, and includes a magnifier-and-focus switching unit 211, an image acquiring unit 112, a zoom processing unit 113, an image processing unit 214, and a change-over-time detecting unit 315.

The change-over-time detecting unit 315 is a processing unit that monitors an image output from the image acquiring unit 112 and detects whether the image changes with the passage of time. More specifically, this change-over-time detecting unit 315 monitors the image output from the image acquiring unit 112, detects a difference value from the image being changed with the passage of time, and determines whether the detected difference value fits within a predetermined range. When the detected difference value stays in the predetermined range for a predetermined period of measurement time, the change-over-time detecting unit 315 sends unchanged image notification indicating that the image being acquired has been unchanged, to the controlling unit 330.

The controlling unit 330 is a processing unit that carries out the control of the entire cellular telephone 300. More specifically, the controlling unit 330 causes the cellular telephone 330 to function as an integrated device, by transferring controls between the functional units, exchanging data, starting up and shutting down applications. Among those processes, the process of the controlling unit 330 most closely related to the present invention is to turn the light 106 on and cause the image acquiring unit 112 to start the process of internally outputting the image to the zoom processing unit 113 upon receipt of an instruction of setting magnifier mode from the magnifier-and-focus switching unit 211.

At the same time as the above, the controlling unit 330 causes the frame-rate controlling unit 240 to fix the frame rate of the image that is to be output from the image acquiring unit 112 to the zoom processing unit 113, to a predetermined rate. Thereafter, the controlling unit 330 causes the zoom processing unit to enlarge, by a predetermined zoom scaling factor, the image acquired by the image acquiring unit 112 and output the enlarged image to the image processing unit 214. Further, the controlling unit 330 causes the image processing unit 214 to process the image enlarged by the zoom processing unit 113 and output the processed image to the displaying unit 105. Finally, the controlling unit 330 causes the change-over-time detecting unit 315 to start monitoring the image output from the image acquiring unit 112 with the passage of time.

On the other hand, when received an instruction of canceling the magnifier mode from the magnifier-and-focus switching unit 211, the controlling unit 330 turns the light 106 off; causes the image acquiring unit 112 to stop outputting the image to the zoom processing unit 113; causes the frame-rate controlling unit 240 to set the frame rate of the image output to the zoom processing unit 113, back to a standard rate; causes the zoom processing unit 113 to set the zoom scaling factor of the image output to the image processing unit 214 to a standard factor; causes the image processing unit 214 to stop processing the image output to the displaying unit 105; and causes the change-over-time detecting unit 315 to stop monitoring the change of the image output from the image acquiring unit 112 with the passage of time.

The controlling unit 330 determines that the cellular telephone 300 is left idle in the magnifier mode when it receives an unchanged image notification from the change-over-time detecting unit 315. Then, the controlling unit 330 switches the cellular telephone 300 to a power saving mode to reduce power consumption by, for example, dimming the backlight of the displaying unit 105 and the sub-displaying unit 207.

As described above, according to the third embodiment, the change-over-time detecting unit 315 monitors the image output from the image acquiring unit 112 and detects whether the image is changing with the passage of time. When the image is determined to be unchanged, the controlling unit 330 switches the cellular telephone 300 to the power saving mode. Thus, when the user is no longer using the magnifying function of the cellular phone, the power consumption of the cellular phone can be automatically cut down.

According to the third embodiment, the controlling unit 330 switches the cellular telephone 300 to the power saving mode when an unchanged image notification is received. The controlling unit 330 may sound a beep tone by means of a speaker or the like so that the user is notified that the cellular telephone 300 is left idle in the magnifier mode.

The above embodiments deal with a cellular telephone, but the present invention is not limited thereto. The present invention is equally applicable to a camera-equipped PDA and a mobile computer.

In addition, although the above embodiments deal with a cellular telephone to which the present invention is applied, a program of controlling a cellular telephone having similar functions can be achieved by realizing the above explained functional structure by software. The following explanation will be focused on a cellular telephone 400 that executes this controlling program.

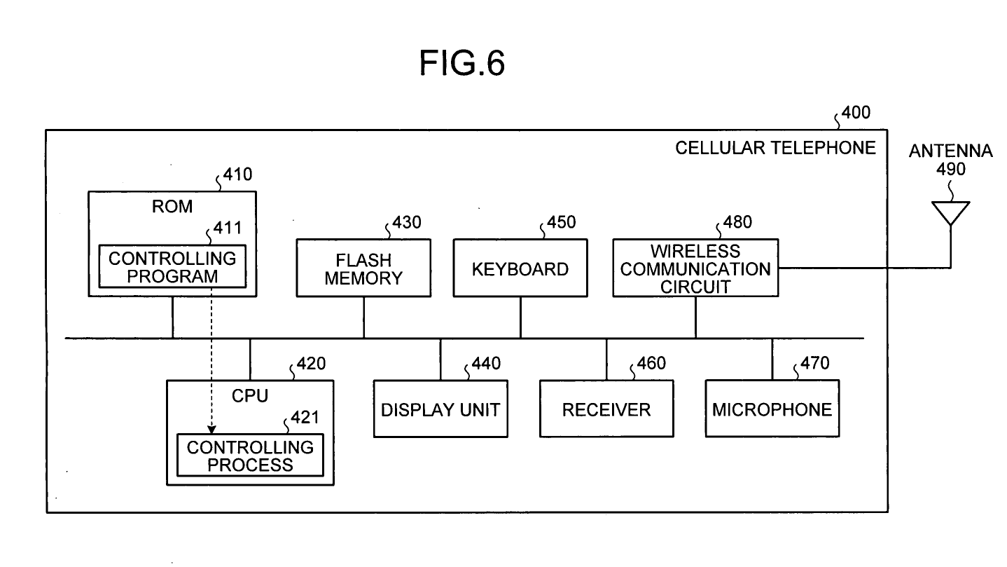

FIG. 6 is a functional block diagram of a cellular telephone 400 that executes the controlling program according to the first to third embodiments. The cellular telephone 400 includes an ROM 410, a CPU 420, a flash memory 430, a display unit 440, a keyboard 450, a receiver 460, a microphone 470, a wireless communication circuit 480, and an antenna 490.

The ROM 410 is a memory device that stores programs and data. The CPU 420 is a central processing device that reads a program from the ROM 410 and executes it. The flash memory 430 is a semiconductor memory from which programs and data can be read and into which programs and data can be written, and stores data such as telephone numbers and e-mail addresses.

The display unit 440 is a liquid display (i.e., the displaying unit) that displays various types of information, and the keyboard 450 is a set of buttons for inputting characters and numbers. The receiver 460 is a speaker that outputs voice or the like during a call, while the microphone 470 is a microphone through which voice is input during a call.

The wireless communication circuit 480 is an integrated circuit that executes a process of generating radio waves that are to be transmitted through the antenna 490 and a process of demodulating the radio wave received through the antenna 490 into communication data. The antenna 490 is used for transmitting and receiving radio waves.

A controlling program 411 executed by the cellular telephone 400 is stored in advance in the ROM 410, and executed as a controlling process 421 by the CPU 420.

The controlling program 411 does not necessarily have to be stored in the ROM 410. It may be downloaded from another computer in advance or via a network, and stored in the flash memory 430. Otherwise, it may be stored in an external, detachable memory device, such as a memory card.

According to an aspect of the present invention, the focal distance between an image acquiring device and an object is switched from the first focal distance to the second focal distance, or from the second focal distance to the first focal distance, in accordance with which the display scale of an image on the display is changed. Thus, the image on the display can be enlarged or reduced by the user with a single, simple operation. This allows the image acquiring device to be readily used as a magnifier or the like. In addition, a camera-equipped mobile terminal device can serve more uses especially for users who tend to avoid complicated operations.

Moreover, when the focal distance is switched from the first focal distance to the second focal distance, the display scale of the image on the display is raised. Thus, the user can readily use the image acquiring device as a magnifier with a single operation. This further promotes the utility value of the camera-equipped mobile terminal device for elderly people or other users with weak eyesight who need a magnifier to read small-font characters.

Moreover, when the focal distance is switched from the first focal distance to the second focal distance, the display scale of the image on the display is reduced. This enables an image of a wider range to be displayed on the displaying unit 105 than in normal mode. For instance, when an image of a targeted object does not fit within the displaying unit 105, a user can display and photograph the object in a wide range with a single operation.

Furthermore, when the focal distance is switched from the first focal distance to the second focal distance, the frame rate of the image on the display is controlled to exceed a predetermined rate. This allows for a stable display of the image, and improves the operability of the image acquiring device when using it as a magnifier.

Moreover, when the focal distance is switched from the first focal distance to the second focal distance, the image on the display undergoes a process. Thus, the image can be displayed with a high visibility by, for example, emphasizing the high-frequency region or adjusting the contrast. As a result, the convenience in using the camera as a magnifier is enhanced.

Furthermore, when the focal distance is switched from the first focal distance to the second focal distance, the user is provided with options of the magnifying function for magnifying an image on the display, the close-up image-acquiring function, and the two-dimensional code reading function, by use of the image acquiring device. When the magnifying function is selected, the display scale of the image on the display is changed. Thus, the user can make use of various functions that are available on the image acquiring device, with a simple operation.

Finally, after the focal distance is switched from the first focal distance to the second focal distance, whether the image that is being acquired by the image acquiring device is changing in a predetermined period of measurement time is detected. When the image acquired by the image acquiring device is detected as being unchanged in the predetermined period of measurement time, the cellular telephone is switched to an energy-saving mode. The cellular telephone-can therefore automatically reduce energy consumption when the user stops using the telephone for the magnifying function.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal device comprising:
a focal-distance setting unit that sets a focal distance to any one of a first focal distance and a second focal distance;
an image acquiring unit that acquires an image of an object based on the focal distance set by the focal-distance setting unit;
a scaling-factor setting unit that sets a scaling factor of the image acquired by the image acquiring unit in accordance with the focal distance set by the focal-distance setting unit; and
a displaying unit that display the image acquired by the image acquiring unit at the scaling factor set by the scaling-factor setting unit.

2. The mobile terminal device according to claim 1, wherein the scaling-factor setting unit sets a relatively higher scaling factor when the focal-distance setting unit sets the focal distance to the second focal distance.

3. The mobile terminal device according to claim 1, wherein the scaling-factor setting unit sets a relatively lower scaling factor when the focal-distance setting unit sets the focal distance to the second focal distance.

4. The mobile terminal device according to claim 1, further comprising a frame-rate controlling unit that controls a frame rate for acquiring the image by the image acquiring unit, wherein the frame-rate controlling unit sets the frame rate to a value not less than a predetermined value when the focal-distance setting unit sets the focal distance to the second focal distance.

5. The mobile terminal device according to claim 1, further comprising a frame-rate controlling unit that controls a frame rate for acquiring the image by the image acquiring unit, wherein the frame-rate controlling unit sets the frame rate to a predetermined value when the focal-distance setting unit sets the focal distance to the second focal distance.

6. The mobile terminal device according to claim 1, further comprising an image processing unit that processes the image when the focal-distance setting unit sets the focal distance to the second focal distance, wherein the display unit displays the image processed by the image processing unit.

7. The mobile terminal device according to claim 2, further comprising a function selecting unit that is used by a user to select any one of a magnifying function with which the image is enlarged when displaying on the display unit, a close-up photography function, and a two-dimensional code reading function, when the focal-distance setting unit sets the focal distance to the second focal distance,
wherein the scaling-factor setting unit changes current scaling factor when the user selects the magnifying function.

8. The mobile terminal device according to claim 1, further comprising an illuminating unit that turns on and illuminates the object when the focal-distance setting unit sets the focal distance to the 'second focal distance.

9. The mobile terminal device according to claim 8, wherein the illuminating unit is a sub-display having a displaying surface that is oriented in the same direction as the image acquiring unit.

10. The mobile terminal device according to claim 1, further comprising:
a change-over-time detecting unit that detects whether the image being acquired by the image acquiring unit changes within a predetermined period after the focal-distance setting unit has set the focal distance to the second focal distance; and
a power-saving setting unit that switches the mobile terminal device to a power saving mode when the change-over-time detecting unit determines that the image is not changing.

11. The mobile terminal device according to claim 1, further comprising:
a change-over-time detecting unit that detects whether the image being acquired by the image acquiring unit changes within a predetermined period after the focal-distance setting unit has set the focal distance to the second focal distance; and
a warning unit that outputs a warning when the change-over-time detecting unit determines that the image is not changing.

12. The mobile terminal device according to claim 1, wherein the first focal distance is a focal distance for normal photography, and the second focal distance is a focal distance for close-up photography.

13. A controlling device for a mobile terminal device, wherein the mobile terminal device includes an image acquiring unit configured to acquire an image of an object and a display unit configured to display acquired image, the controlling device comprising:
a focal-distance setting unit that sets a focal distance of the image acquiring unit to any one of a first focal distance and a second focal distance; and
a scaling-factor setting unit that sets a scaling factor of the image in accordance with the set focal distance by the focal-distance setting unit.

14. A method of controlling a mobile terminal device, wherein the mobile terminal device includes an image acquiring unit configured to acquire an image of an object and a display unit configured to display acquired image, the method comprising:
setting a focal distance of the image acquiring unit to any one of a first focal distance and a second focal distance; and
setting a scaling factor of the image in accordance with set focal distance.

15. A computer-readable recording medium that stores therein a computer program that causes a computer to control a mobile terminal device, wherein the mobile terminal device includes an image acquiring unit configured to acquire an image of an object and a display unit configured to display acquired image, the computer program causing the computer to execute:
setting a focal distance of the image acquiring unit to any one of a first focal distance and a second focal distance; and
setting a scaling factor of the image in accordance with set focal distance.
